(19) United States
(12) Patent Application Publication
(10) Pub. No.: US 2011/0236561 A1
(43) Pub. Date: Sep. 29, 2011

(54) Process For The Manufacture Of A Dietary Paste Based On Vegetable Milk Curds Which Is Enriched With A Dietary Supplement And Dietary Paste Thus Obtained

(76) Inventors: Roland Dumas, Vannes (FR); Tom Swartele, Mahwah, NJ (US)

(21) Appl. No.: 13/061,554

(22) PCT Filed: Sep. 9, 2009
(86) PCT No.: PCT/FR2009/001077

§ 371 Date: May 19, 2011

(30) Foreign Application Priority Data
Sep. 11, 2008 (FR) 08 04992

(51) Int. Cl. A23C 20/02; A23L 1/305

(52) U.S. Cl. 426/648

(57) ABSTRACT

Process for the manufacture of a dietary paste based on vegetable milk curds, enriched with a dietary supplement, allowing uniform incorporation of the dietary supplement in large proportions so that the paste obtained has a pronounced taste, and has the nutritional qualities characteristic of the products derived from an animal milk.

The invention relates to a process for manufacturing a food paste based on vegetable milk curd which is enriched with a food supplement, and to a food paste thus obtained.

More specifically, the invention relates to a process for manufacturing a cheese food paste based on vegetable milk curd, and to a food paste thus obtained.

More particularly, the invention relates to a process for manufacturing a cheese tofu based on soya milk curd and to a cheese tofu with a high content of cheese.

A vegetable milk is a drink based on vegetable ingredients such as soya, coconut, almond, rice, oat, orgeat, etc. These vegetable milks may be purchased commercially.

Many food pastes based on vegetable milk have deficiencies in certain nutrients. It is thus desirable to propose a process for manufacturing a food paste based on vegetable milk that allows the introduction of one or more food supplements in significant proportions, i.e. in which the amount of food supplement powder by weight relative to the amount of the vegetable milk by weight of dry extract is greater than 10%. Examples of food supplements that may be used include cheese powder, potato powder or any other food supplement in powder form in order for it to be able to be mixed with the vegetable milk.

In particular, soya milk is used for the preparation of tofus, which are traditional Asiatic products in the form of a cake or a block of a more or less soft paste.

Soya milk is the result of a known treatment of soya beans, during which soya beans are cleaned, soaked and ground to obtain a broth. This broth is then cooked and filtered to obtain the soya milk.

To manufacture a tofu, the soya milk is clotted, using clotting agents, until a curd and whey are obtained. The whey is discarded and the curd is placed in straining cloths and then pressed to obtain the tofu.

In order to improve the taste of tofus, it has already been proposed to add, during the manufacture of the tofu, citrus extracts or flavorings. However, their proportion is very low relative to the tofu dry matter obtained. In addition, these are not food supplements that can make up for the nutritional deficiencies of tofu.

It has also been proposed to add cheese to tofu. This process is described in Japanese patent JP 61-195 658, which proposes the treatment of cheese with an alkaline substance and its addition to soya milk. Said document proposes the addition of water to the cheese to create a fluid substance of low viscosity, and this substance is dehydrated and spray-dried. The powder thus obtained is then mixed with the soya milk.

However, it has been found that this process allows incorporation into the soya milk of not more than 10% by weight of cheese powder relative to the weight amount of soya milk dry extract during the preparation of the tofu, since beyond 10%, the cheese is not incorporated into the milk and is lost with the whey. The tofu thus has a low cheese content.

The present invention is directed toward proposing a process for manufacturing a food paste that is enriched with food supplement in powder form, allowing a uniform incorporation of this powder in large proportions in order for the food paste obtained to have improved nutritional qualities and especially nutritional qualities characteristic of products derived from an animal milk.

More particularly, the present invention is directed toward proposing a process for manufacturing a cheese tofu that allows a uniform incorporation of cheese in large proportions in order for the tofu to have, besides improved nutritional qualities, a pronounced cheese flavor.

The Applicant realized that by modifying the manufacture of the food supplement powder, a larger amount of food supplement can be incorporated into the vegetable milk, and the food paste obtained has good homogeneity, a good texture, improved nutritional qualities and, depending on the food supplement incorporated, a more pronounced flavor.

To this end, one subject of the present invention is a process for manufacturing a food paste based on vegetable milk curd, which is enriched with food supplement, the process comprising the following steps:
emulsification, in water, of a food supplement and an emulsifier;
drying of the emulsion obtained in the preceding step on a steam roll, the steam being injected into the roll at a temperature of between about 130 and 150° C., preferably at about 140° C., and at a pressure such that the internal pressure of the roll is between 3.6 and 7 bar, so as to obtain a dehydrated film of food supplement;
grinding of the film obtained in the preceding step in order to obtain a dehydrated food supplement powder;
mixing of the food supplement powder thus obtained into the vegetable milk;
addition of a clotting agent into the mixture obtained in the preceding step in order to obtain a curd and whey; and
removal of the whey, and separation and then pressing of the curd so as to obtain the food paste.

According to other embodiments of the invention:
the food supplement may be chosen from a cheese, a mixture of cheeses, a fruit, a mixture of fruits, a vegetable, a mixture of vegetables, and a mixture thereof;
the vegetable milk may be soya milk, and the food paste obtained after pressing of the curd, a tofu;
the step of mixing the food supplement powder with the vegetable milk may comprise the following substeps:
   dissolution of the food supplement powder in water in a proportion of one dose of food supplement powder per two to five doses of water, preferably three doses of water; and
   mixing of the solution thus obtained with the vegetable milk;
the weight amount of dehydrated food supplement powder relative to the weight amount of vegetable milk dry extract is between about 11% and 100% and preferably between about 40% and 80%.

The invention also relates to a food paste based on vegetable milk curd that is enriched with food supplement, which may be obtained via the preceding manufacturing process, in which the weight amount of food supplement powder relative to the weight amount of the vegetable milk dry extract is between about 11% and 100% and preferably between about 40% and 80%.

According to other embodiments of the invention:
the food supplement is chosen from a cheese, a mixture of cheeses, a fruit, a mixture of fruits, a vegetable, a mixture of vegetables, and a mixture thereof;
the vegetable milk may be soya milk, and the food paste obtained after pressing the curd, a tofu.

In the rest of the description, the invention will be described for the manufacture of a cheese tofu from soya milk and cheese powder.

According to one implementation example of the invention, cheese powder is prepared using steam-drying rolls (Hatmaker process) from cheese that has undergone an alkaline treatment.

Implementation examples are collated in the following table, illustrating the alkaline treatments to be performed for various types of starting material.

| | F/D* | | | | % | |
|---|---|---|---|---|---|---|
| | Starting | Target | Target | % | melding | % |
| Starting material | material | DE** | F/D | cheese | salt | water |
| Camembert | 45 | 35 | 44 | 77 | 1.8 | 21.2 |
| St-Albray ® | 50 | 35 | 48 | 62 | 1.8 | 36.2 |
| cheese | | | | | | |
| specialty/ | | | | | | |
| Chaumes ® | | | | | | |
| cheese specialty | | | | | | |
| Fol Epi ® cheese | 52 | 35 | 50 | 56 | 1.8 | 42.2 |
| specialty | | | | | | |
| Offcuts of slices | 55 | 35 | 53 | 60 | 1.8 | 38.2 |
| of Bresse Bleu ® | | | | | | |
| cheese specialty | | | | | | |
| Camembert/Brie | | 35 | 51 | 39% | 1.8 | 27.2 |
| mixture | | | | Cam- | | |
| | | | | embert | | |
| | | | | 32% | | |
| | | | | Brie | | |

*F/D: Fat/Dry (% relative to the dry matter);
**DE: Dry Extract

These starting materials are both “designation of origin” cheeses, such as Camembert or Brie, and industrial cheeses, given under their trade name (Saint Albray®, Chaumes®, Fol Epi®, Bresse Bleu®, Etorki®, Chavroux® and Caprice des Dieux® cheese specialties).

In accordance with the process according to the invention, the cheese starting material is premixed with an emulsifier in water. The emulsifier is used to give a uniform mixture during the emulsification step. When the food supplement is cheese or a mixture of cheeses, the emulsifier is a melding salt. By way of example, the melding salts that may be used are sodium phosphate, sodium orthophosphate and, preferably, the salt Joha-S9D from the company Joha. The latter melding salt allows excellent mixing for the rest of the process, increases the pH, improves the ion exchange and does not have any creaming power.

This emulsion is then dried on a Hatmaker steam roll at a temperature of between 130° C. and 150° C., and preferably at 140° C., and at a pressure such that the internal pressure of the roll is between 3.6 and 7 bar. To this end, the pressure is injected, for example, at a pressure of between 8 and 14 and preferably between 10 and 12 bar. After passing over the steam rolls, a dehydrated cheese film is obtained, which is reduced to powder, for example by rotary brushes, or by any other grinding means. The term “dehydrated film or powder” means a film or a powder containing less than 5% by weight of water.

The temperature and pressure may be adapted as a function of the homogeneity of the emulsion. If the emulsion is very homogeneous, the temperature and pressure may be high. If the emulsion is not homogeneous, the temperature and pressure should be reduced so as not to burn the components.

The dehydrated cheese powder thus obtained may be stored for the subsequent preparation of a cheese tofu based on soya milk curd.

For the preparation of this tofu, the cheese powder obtained previously is mixed with the soya milk so that the cheese becomes rehydrated in the milk.

Surprisingly, the weight amount of dehydrated cheese powder, obtained previously, relative to the weight amount of vegetable milk dry extract is between about 11% and 100% and preferably between about 40% and 80%. The cheese powder has a rehydration capacity higher than that of the powder obtained by atomization, by virtue of greater denaturing of the protein. The cheese powder thus has better gelling power, and as such the mixing of the powder and the vegetable milk takes place easily without the need to add an emulsifier.

By way of example, a first cheese tofu was prepared by mixing 0.2 kg of cheese powder, dehydrated on a steam roll, with an amount of soya milk such that the amount of soya milk dry extract was about 1.8 kg. This mixture was prepared in a yield of 100%, i.e. all the mixed cheese was found in the tofu. The weight amount of dehydrated cheese powder relative to the weight amount of vegetable milk dry extract is thus about 11% (0.2/1.8*100).

A second cheese tofu was also prepared by mixing 1.8 kg of cheese powder, dehydrated on a steam roll, with an amount of soya milk such that the amount of soya milk dry extract was about 1.8 kg. This mixture was prepared in a yield substantially equal to 100%, i.e. virtually all the mixed cheese was found in the tofu, a tiny amount being found in the whey. The weight amount of dehydrated cheese powder relative to the weight amount of vegetable milk dry extract is thus about 100% (1.8/1.8*100).

This mixture is prepared with a soya milk that is hot, i.e. preferably at a temperature of between 80 and 95° C. Preferably, the cheese powder is rehydrated beforehand in water in a proportion of one dose of cheese powder per two to five doses of water, preferably per three doses of water. The solution thus obtained is then mixed with the soya milk.

A clotting agent is then added to this mixture to make it clot. The clotting agents that may be used are, for example, “nigari” (a traditional Japanese clotting agent formed from the residue obtained from seawater from which the water and the sodium chloride have been extracted), magnesium chloride, calcium chloride in anhydrous or hydrated form, calcium sulfate, magnesium sulfate, glucono-delta-lactone, etc.

The product thus obtained is composed of a liquid part known as whey and a solid part known as curd.

The whey is discarded and the curd is pressed to remove an amount of liquid sufficient to obtain a tofu of the desired consistency. This tofu is then stripped from the press, chopped and wrapped for consumption.

By virtue of the preparation of the cheese powder on steam rolls, this powder has characteristics that allow it to be incorporated in a high proportion of greater than about 11% by weight amount of dehydrated cheese powder relative to the weight amount of vegetable milk dry extract, and up to about 100%, in a yield close to 100%, i.e. substantially all the cheese incorporated into the milk is found in the tofu.

In addition, this mixture of powder and milk is obtained easily without additional addition, for example of an emulsifier, and its stability is compatible with the manufacture of tofu.

The tofu thus obtained has a large amount of cheese flavoring with, in addition, a slight cooked taste.

In the tofu thus obtained, the weight amount of cheese powder relative to the weight amount of soya milk dry extract may be between about 11% and 100% and preferably between about 40% and 80%. In these proportions, about 100% of the cheese incorporated into the soya milk is found in the tofu.

Beyond a ratio of the weight amount of dehydrated cheese powder to the weight amount of vegetable milk dry extract of 100%, problems of loss of material arise, i.e. some of the cheese powder mixed with the soya milk is not found in the curd and is removed with the whey. The yield is thereby affected. Below a ratio of the weight amount of dehydrated cheese powder to the weight amount of vegetable milk dry extract of about 11%, the food paste obtained does not have a sufficiently pronounced cheese flavor and is not sufficiently enriched with nutrients.

According to other embodiments, the food supplement may be chosen from a fruit, a mixture of fruits, a vegetable, a mixture of vegetables, and a mixture thereof. By way of example, potatoes, carrots, beans, aubergines, etc. may be used. Preferably, the food supplement is chosen from those that have a high protein content.

1. A process for manufacturing a food paste based on vegetable milk curd, which is enriched with food supplement, characterized in that it comprises the following steps:
emulsification, in water, of a food supplement and an emulsifier;
drying of the emulsion obtained in the preceding step on a steam roll, the steam being injected into the roll at a temperature of between about 130 and 150° C., and at a pressure such that the internal pressure of the roll is between 3.6 and 7 bar, so as to obtain a dehydrated film of food supplement;
grinding of the film obtained in the preceding step in order to obtain a dehydrated food supplement powder;
mixing of the food supplement powder thus obtained into the vegetable milk;
addition of a clotting agent into the mixture obtained in the preceding step in order to obtain a curd and whey; and
removal of the whey, and separation and then pressing of the curd so as to obtain the food paste.

2. The process as claimed in claim 1, in which the food supplement is chosen from a cheese, a mixture of cheeses, a fruit, a mixture of fruits, a vegetable, a mixture of vegetables, and a mixture thereof.

3. The process as claimed in claim 1, in which the vegetable milk is soya milk, and the food paste obtained after pressing the curd is a tofu.

4. The process as claimed in claim 2, in which the step of mixing the food supplement powder with the vegetable milk comprises the following substeps:
dissolution of the food supplement powder in water in a proportion of one dose of food supplement powder per two to five doses of water; and
mixing of the solution of rehydrated food supplement thus obtained with the vegetable milk.

5. The process as claimed in claim 1, in which the weight amount of dehydrated food supplement powder relative to the weight amount of vegetable milk dry extract is between about 11% and 100%.

6. A food paste based on vegetable milk curd which is enriched with food supplement, which may be obtained via the manufacturing process as claimed in claim 1, in which the weight amount of food supplement powder relative to the weight amount of vegetable milk dry extract is between about 11% and 100%.

7. The cheese food paste as claimed in claim 6, in which the food supplement is chosen from a cheese, a mixture of cheeses, a fruit, a mixture of fruits, a vegetable, a mixture of vegetables, and a mixture thereof

8. The cheese food paste as claimed in claim 6, in which the vegetable milk is soya milk, and the food paste obtained after pressing the curd is a tofu.

9. The process as claimed in claim 1, in which the steam is injected into the roll at a temperature of about 140° C.

10. A food paste based on vegetable milk curd which is enriched with food supplement, which may be obtained via the manufacturing process as claimed in claim 1, in which the weight amount of food supplement powder relative to the weight amount of vegetable milk dry extract is between about 40% and 80%.

11. The process as claimed in claim 1, in which the weight amount of dehydrated food supplement powder relative to the weight amount of vegetable milk dry extract is between about 40% and 80%.

12. The process as claimed in claim 4, in which the weight amount of dehydrated food supplement powder relative to the weight amount of vegetable milk dry extract is between about 40% and 80%.
